(19) United States
(12) Patent Application Publication
(10) Pub. No.: US 2007/0240716 A1
(43) Pub. Date: Oct. 18, 2007

(54) Personal air filtering and isolation device

(76) Inventor: Alvin J. Marx, San Antonio, TX (US)

Correspondence Address: Michelle L. Evans;Gunn, Lee & Hanor, PC, Suite 1500, 700 N. St. Mary's St., San Antonio, TX, 78205, US

(21) Appl. No.: 10/624,870

(22) Filed: Jul. 22, 2003

Related U.S. Application Data
(63) Continuation-in-part of application No. 10/075,900, filed on Feb. 15, 2002, now abandoned.

(51) Int. Cl. A62B 7/10

(52) U.S. Cl. 128/204.21

(57) ABSTRACT

An air filtering device is presented with a face mask of nonporous material, the face mask held onto the user's head by standard elastic straps. The face mask has a flexible gasket about its perimeter to provide an airtight seal between the mask and the user's face. The face mask has an exhaust filter that lets exhaled air out of the mask, but does not let unfiltered air into the mask. A flexible tube enters the face mask at one end and enters an air filtering assembly on the opposite end. The air filtering assembly is enclosed in a housing with the housing having an air intake opening. The air filtering assembly has an air moving device such as a fan or pump, a carbon filter cartridge, a particulate matter filter, a battery power supply, and an on-off switch.

This is a continuation in part application claiming priority to U.S. patent application Ser. No. 10/075,900 filed Feb. 15, 2002.

### BACKGROUND OF THE INVENTION

1. Field of the Invention

This invention relates generally to the field of face masks, and more particularly to a personal air filtering and isolation device. The present invention is even more particularly a positive pressure air system designed to provide high quality air, relatively free of particulate and biological contaminants to the users while they perform their normal life activities, and also to provide the option to isolate the environment from the user to limit the potential for spreading communicable diseases. A secondary major benefit is to decrease the airway dead space and thereby the amount of inhaled carbon dioxide and water vapor.

2. Background Information

There are conditions that arrive, either natural or man made, that cause the air we breathe to become polluted with various contaminants such as harmful particulate matter or gasses. Various types of face masks have been developed in the past that protect the user from airborne pollutants.

Dust masks have been developed to protect people from larger particulate matter such as sand, wood dust, metal dust or the like. These masks usually are made from non-woven filter paper or woven cloth. They are held on with elastic bands. Other more comprehensive filtering masks have been designed for removing smaller particulate matter as well as some gases. These masks are used to filter the fumes from spray paint and various harmful solvents and the like. These masks often include cartridges with filtering material such as activated charcoal. At the more extreme level, gas masks have been developed to protect people from potentially deadly gasses and particles that may include bacteria, viruses and the like. These masks usually cover most of the face and are made of a nonporous rubber material and include finer gas and particle filtering elements.

Although the above mentioned masks have proven to be effective for their intended uses, current uses require an improved and novel configuration that cannot be found in the existing units. Currently, there are many locations in the world where the ambient air, that is, the air we normally breathe while walking down the street, may be harmful to one's health. In these places, the air contains increased particulate matter, and harmful byproducts that are generated by vehicle and factory emissions, and sprays of pesticides whose harmful particles carryover to populated areas. Most recently, the danger of inhaling SARS (Severe Acute Respiratory Syndrome) viruses, or weapons grade spores of Anthrax particles released by terrorists have caused people to desire protection from potentially inhaling these deadly viruses and bacteria. While the SARS virus measures 0.08 microns, it is transmitted in water droplets that are 0.3 microns or larger. The anthrax spore can be as small as two-tenths of one micron in diameter. These changed spores are then mixed with a powder. Although there are types of military gas masks that may protect a person from the above mentioned pollutants, they tend to be cumbersome, claustrophobic and expensive to manufacture and purchase. Additionally, they are unacceptable from a fashion point of view for wearing under every day conditions. It would certainly turn heads to see a person walking down the street wearing a military style gas mask. Finally, current designs of most filtering masks cause a build up of carbon dioxide and water vapor between the inside of the mask and the user's face because of the increase in dead space. The introduction of fresh air is limited by the construction of the mask. In these instances it is uncomfortable to wear such a mask for prolonged periods of time, such as when walking for long periods of time outdoors, standing in the operating room, or the like.

The present invention provides for a positive pressure air system designed to provide high quality air, relatively free of particulate, organic and biological contaminants to the user while the user performs normal life activities and also to provide the option to isolate the environment from the user to limit the potential for spreading communicable diseases. The present invention provides for ease of use and comfort while in use. It can also be used for extended periods of time with power from a battery and/or other low voltage power supply. Since the present invention is a positive pressure system, significant advantages in user comfort and efficiency of filtration are achieved. Extended use can be achieved through a very simple and quick battery exchange allowing continuous use for eight hours or more. The filter is also quickly and easily replaced allowing virtually unlimited use of this device.

### SUMMARY OF THE INVENTION

An object of the present invention is to provide a personal air filtering device that is portable and can be worn for continuous periods of time.

Another object of the invention is to provide a personal air filtering device that delivers a substantial amount of fresh air by drawing or forcing air into a filter and delivering it to a mask portion that fits snuggly on a user's face. In the alternative and preferred embodiments, positive air flow allows the face mask to better fit the user's face, improving comfort. Delivery of air to the sides of the mask with an exit at the front of the mask further decreases the dead space.

Another object of the invention is to provide a personal air filtering device that is designed to create a relatively inconspicuous appearance so that it does not draw excessive attention to the wearer while using the present invention in public.

Another object of the invention is to provide a personal air filtering device that is relatively light weight and economical to manufacture.

Another object of the invention is to provide a personal air filtering device that is battery powered.

A further object of the invention is to provide a personal air filtering device that can protect the user from breathing in very fine airborne pollutants.

An additional object of the present invention is to provide a novel personal air filtering device that can provide high quality air relatively free of contaminants. Positive air flow forcibly exhausts exhaled air reducing carbon dioxide intake and water vapor, keeping air cooler, reducing build up of moisture, and generally improving comfort.

Still another object of the present invention is to provide a novel personal air filtering device that allows a user to perform his or her normal life activities while wearing the mask.

It is an additional object of the present invention to provide a novel personal air filtering device that is fully cleanable while isolating the contaminants from the user during cleaning.

It is another object of the present invention to provide a novel personal air filtering device that provides an exhaust filter to isolate the environment from the user by capturing biological material exhaled by the user.

An additional object of the present invention is to provide a novel personal air filtering device that supplies positive pressure filtered air to the user.

Still another object of the present invention is to provide a novel personal air filtering device that is compact, fully self-contained, light weight and simple to use.

It is yet an additional object of the present invention to provide a novel personal air filtering device that allows for rapid hygienic filter changes.

Another object of the present invention is to provide a novel personal air filtering device that can filter a broad range of contaminants including, but not limited to, simple particulates, allergens, bacteria, water borne mist viruses and organic vapors. Simply selecting the appropriate filter cartridge allows the user to filter the substance of concern.

Still another object of the present invention is to provide a novel personal air filtering device that can be carried on the user by belt, shoulder, or backpack.

It is an additional object of the present invention to provide a novel personal air filtering device that is small enough to fit under a coat or other outerwear.

Yet another object of the present invention is to provide a novel personal air filtering device that has automatic sensors for detecting the need to change the filter.

It is still another object of the present invention to provide a novel personal air filtering device that has an automatic sensor to detect a low battery.

An additional object of the present invention is to provide a novel personal air filtering device that is fully portable by operation from a battery or can be operated from a wall electricity adaptor.

Still another object of the present invention is to provide a novel personal air filtering device that provides fresh filtered air to the nose and mouth area eliminating the accumulation of carbon dioxide and water vapor that causes the hot claustrophobic feeling of conventional face masks. This mask requires only a minimal effort to breathe allowing more natural breathing for the user.

It is an additional object of the present invention to provide a novel personal air filtering device that allows the user to draw additional air through the filter and blower during times of increased respiration.

Yet it is another object of the present invention to provide a novel personal air filtering device that allows the user to continue breathing even if the blower stops running due to loss of power (low battery) or failure of the blower itself.

An additional object of the present invention is to provide a novel personal air filtering device that provides a blower motor and battery that are external to the air flow chambers insuring minimal risk to the user of inhaling toxic gases given off by the battery or motor material in case of failure (short circuit).

A further object of the present invention is to provide a novel personal air filtering device that is easy to decontaminate and/or clean and especially prevents the accumulation of bacteria and viruses within the system.

Other objects and advantages of the present invention will become apparent from the following descriptions, taken in connection with the accompanying drawings, wherein by way of illustration and example, embodiments of the present invention are disclosed.

A personal air filtering device is disclosed having a face mask of nonporous material. The face mask is held onto the user's head by standard elastic straps and has a flexible gasket about its perimeter to provide an airtight seal between the mask and the user's face. The face mask has an exit exhaust filter that lets exhaled air out of the mask, but does not let unfiltered air into the mask. There may also be a filter at the exit valve. A flexible Y-shaped tube is provided that enters the face mask on one side and attaches an air filtering assembly on the opposite end. The air filtering assembly is enclosed in a housing. The housing has an air intake opening. The air filtering assembly includes an air moving device such as a fan or pump, a carbon filter cartridge, a particulate matter filter, such as a P-95 or N-95 filter, a battery power supply, and an on-off switch. The activated carbon intake filter can be designed to remove either two-tenths of one micron particles or five to ten micron particles and organic matter. The exit filter will remove particles as small as 0.2 microns.

More particularly, the present invention provides a positive pressure air system designed to provide high quality air, relatively free of particulate, organic and biological contaminants to the user while the user performs his or her normal life activities and also to provide the option to isolate the environment from the user to limit the potential for spreading communicable diseases.

The drawings constitute a part of this specification and include exemplary embodiments to the invention, which may be embodied in various forms. It is to be understood that in some instances various aspects of the invention shown may be exaggerated or enlarged to facilitate an understanding of the invention.

### BRIEF DESCRIPTION OF THE DRAWINGS

FIG. 1 is a perspective front view of a person wearing the personal air filtering device of one embodiment of the present invention.

FIG. 2 is a front view of the housing of the air filter of one embodiment of the present invention showing a carbon filter cartridge about to be inserted into the housing.

FIG. 3 is a perspective rear view of a person wearing the personal air filtering device of one embodiment of the present invention.

FIG. 4 is a side section view of the housing of the air filter of one embodiment of the present invention.

FIG. 5 is a front perspective view of a person wearing an anthrax filtering design of another embodiment of the present invention.

FIG. 6 is a perspective front view of a person wearing the personal air filtering device of an alternative embodiment of the present invention.

FIG. 7A is a front view of the face mask of the alternative and preferred embodiments of the present invention.

FIG. 7B is a back view of the face mask of the alternative and preferred embodiments of the present invention.

FIG. 8A is a perspective view of the housing, battery cassette and AC adaptor for the alternative embodiment of the present invention.

FIG. 8B is a perspective view of the housing, battery cassette and AC adaptor for the alternative embodiment of the present invention showing one of the filters removed.

FIG. 9 is a side perspective view of the housing of the alternative embodiment of the present invention.

FIG. 10 is a top view of inside of the pressure plenum of the alternative embodiment of the present invention.

FIG. 11 is a top view of the inside of the vacuum plenum of the alternative embodiment of the present invention.

FIG. 12 is an exploded view of a small scale version of the filter device of the alternative embodiment, more specifically the preferred embodiment, of the present invention.

FIG. 13A is a perspective view of the blower housing of the preferred embodiment of the present invention.

FIG. 13B is another perspective view of the blower housing of the preferred embodiment of the present invention.

### DETAILED DESCRIPTION OF THE PREFERRED EMBODIMENT

Detailed descriptions of the preferred embodiment are provided herein. It is to be understood, however, that the present invention may be embodied in various forms. Therefore, specific details disclosed herein are not to be interpreted as limiting, but rather as a basis for the claims. Also these details represent the basis for teaching one skilled in the art to employ the present invention in virtually any appropriate system, structure or manner.

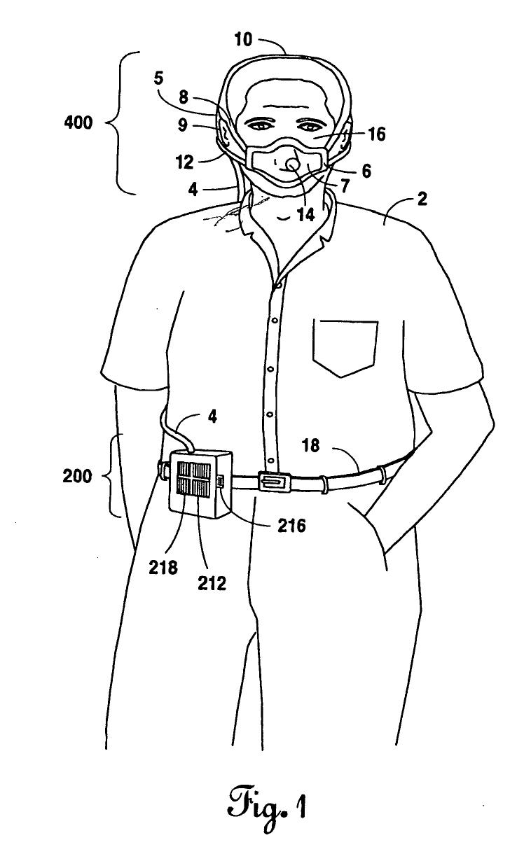

Referring now to FIG. 1 a perspective view of a person 2 wearing the air filter assembly 200 and mask assembly 400 of one embodiment of the present invention is shown. The mask assembly 400 is comprised of a nonporous contoured shell 7 that can be made of rigid or resilient material. One embodiment envisioned uses clear plastic material for the contoured shell 7 so that there is a minimum imposition on the normal appearance of the wearer. A resilient gasket 6 surrounds shell 7 and the user's face 16. A one-way valve 14 allows person 2 to breathe out expired air through the valve 14, but not to breathe air into the valve 14. Adding a filter after the one-way valve 14 would protect other personnel from viruses and/or bacteria exhaled by the patient. Air tube portion 5 is contoured to fit neatly around the user's ear 9 and to enter the shell 7 at point 8. Shell 7 and gasket 6 are held onto the user's face 16 by elastic bands 12, 10 that are configured in the standard way that many current masks use. The elastic band 12 surrounds the user's neck and elastic band 10 surrounds the top portion of the user's head. Air tube portion 5 connects directly to flexible air tube 4 that travels down the user's back and curves around the user's waist and into air filter assembly 200. The air filter assembly 200 is worn on belt 18 or as a vest. Housing 210 has an opening 218 in its front surface to allow air to enter the carbon filter cartridge 212. Tab 216 allows the user to pull out cartridge 212 for replacement when the carbon in the cartridge 212 is saturated.

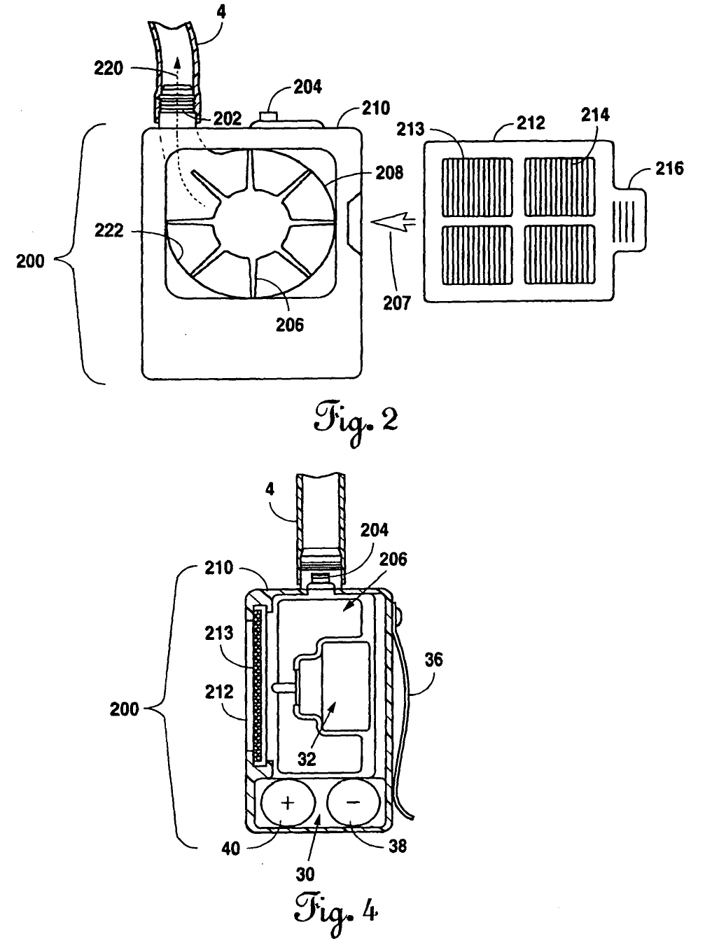

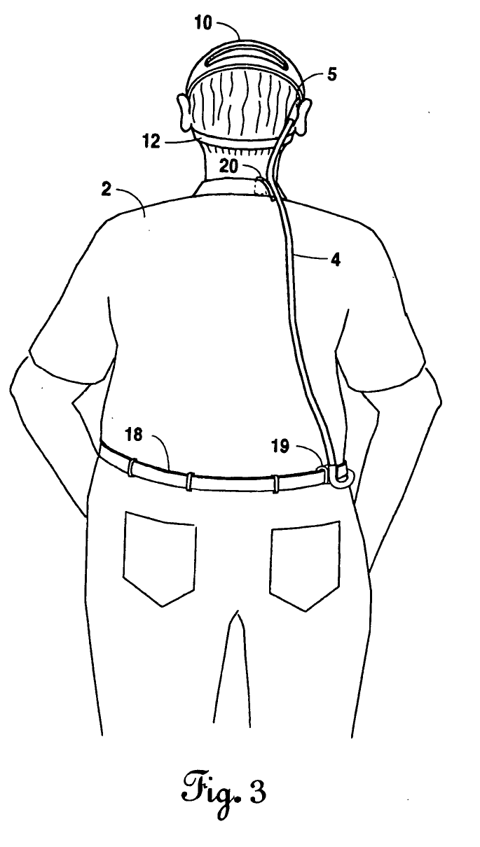

FIG. 2 shows a front view of the air filter assembly 200 and the carbon filter cartridge 212 of one embodiment. This carbon filter (not shown) in cartridge 212 should remove particles of five to ten microns in size. The cartridge 212 is a hollow box like structure whose front and back panels have a plurality of finely spaced ribs 1214 separated by gaps that let air pass into and through the carbon granules 213 located within the cartridge 212. The cartridge 212 plugs into housing 210 as indicated by the arrow 207. Tab 216 helps the user pull cartridge 212 out of the housing 210. Impeller 206 spins and causes air to be drawn into housing 210, through cartridge 212, along wall 208 and up through air tube 4 as indicated by dotted line 220. Switch 204 turns motor 32 (See FIG. 4) on and off.

Referring to FIG. 3 a rear view of person 2 wearing the air filter assembly 200 of one embodiment of the present invention is shown. Air tube 4 is shown running up the back and side portion of the user's torso on his or her belt 18. Tube support clip 19 helps hold air tube 4 in place near its lower portion. Shirt clip 20 holds air tube 4 in place near its upper portion. Tube portion 5 is made of rigid material so that it can closely follow the contour of the user's ear and face. Elastic bands 10 and 12 can be clearly seen holding the mask assembly 400 in place on the user's head.

FIG. 4 shows a side section view of the air filter assembly 200 of one embodiment. Housing 210 is shown. Batteries 38, 40 are provided within battery portion 30 to power motor 32. Motor 32 spins impeller 206 causing air to be drawn through the carbon granules 213 of cartridge 212 as described above. Spring clip 36 holds the air filter assembly 200 onto the user's belt 18 (See FIG. 1). Switch 204 turns motor 32 on and off.

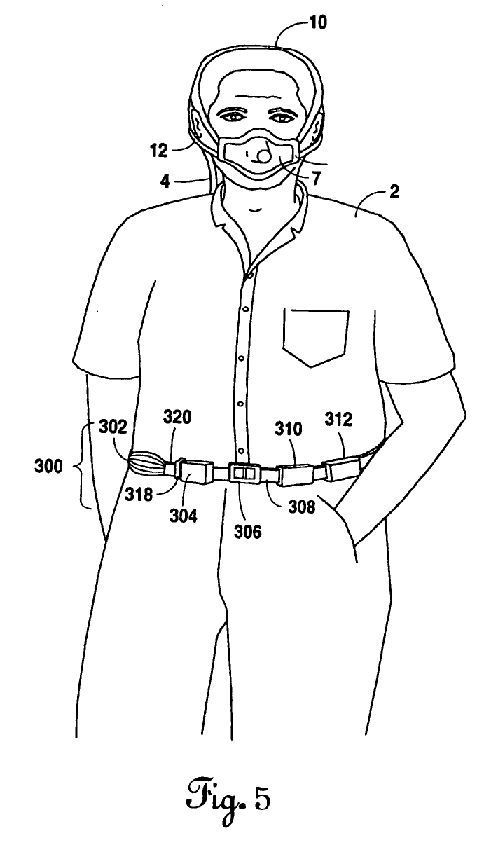

FIG. 5 shows an anthrax filtering design of another embodiment 300 of the present invention. Again, a person 2 is shown with the shell 7 over his or her face held in place with elastic bands 10 and 12 and air tube 4 extending there from. A rotary vane pump 304, such as the series 3600 pump made by Procon of Murfeesboro, Tenn., pumps air through a one tenth of one micron filter 318, such as the microfilter element made by Meissner Filtration of Camarillo, Calif. This filter should remove water droplets containing SARS virus, and weapons grade anthrax as small as two tenths of one micron. Additionally, an activated carbon absorber 320 will be employed to remove trace organics. One such carbon filter is the Nitox filter made by Tigg Corporation of Herber Springs, Ariz. As an option, the air can be pumped into a flexible bladder 302, such as the one made by Perma Type Rubber Corporation of Plainville, Conn. The bladder 302 collects air as the user exhales and supplies the air up air tube 4 and into mask assembly 400 as the user breathes in. Battery packs 310, 312 power the pump 304. The entire assembly is attached to belt 308 which is secured by belt buckle 306. This embodiment as shown in FIG. 5 is designed to filter the finest airborne particles including anthrax.

FIG. 6 is a perspective front view of a person 2 wearing the personal air filtering device of the alternative embodiment of the present invention. This personal air filtering device 500 includes a face mask 502 and a blower housing 510. Face mask 502 is preferably translucent and lightweight. Face mask 502 is secured to the person's 2 head by way of a head band 504. In addition, face mask 502 can vary slightly depending on the environment and may incorporate a pleasant scent. This will improve compliance for children and other reluctant subjects. The construction of head band 504 can also vary depending on the weight of the face mask 502. Blower housing 510 is attached to a belt 18 and is connected to face mask 502 by way of primary tube 506 and secondary tubes 508. Primary tube 506 connects to secondary tubes 508 by way of Y-connector 524. A single tube (not shown), preferably of a large non-hindering diameter, can substitute for primary tube 506, secondary tubes 508, and Y-connector 524 being able to connect at one end to face mask 502 under exhaust filter 522 and at the other end to air outlet 518. The use of the single tube (not shown) can significantly reduce the weight of this embodiment and improve the aesthetics.

Primary tube 506 is preferably of a larger diameter than secondary tubes 508 to prevent air flow restriction. Primary tube 506 is preferably corrugated to improve flexibility of the tube without the risk of kinking. The corrugated construction also allows for the use of thinner tube walls which reduces weight. In addition, the corrugated tubing provides a significant improvement in air flow over non-corrugated tubing due to the more consistent cross sectional area which reduces air flow restriction.

Secondary tubes 508 connect to face mask 502 by way of inlet ports 520. Inlet ports 520 have an optional pivoting quick-disconnect fitting (not shown) to facilitate the removal of face mask 502 for replacement. The exhaust filter 522 is provided at the front of face mask 502. Air outlet 518 connects primary tube 506 to blower housing 510. This air outlet 518 has an optional pivoting quick-disconnect fitting (not shown) to facilitate the removal of primary tube 506 for periodic replacement. Blower housing 510 has at least two filters 516 and a battery cassette 512. The filters 516 are more specifically filter assemblies 588 composed of a filter carrier 580 which allows the assembly 588 to twist onto the blower housing 510, a coarse 100 micron outer filter 584 (See FIG. 8A) bonded to a metal grill work 582 (See FIG. 8A), and an inner P95 or N95 (0.3 micron) fine composite filter (not shown). The N95 filter is preferably a 0.3 micron polypropylene filter sandwiched between two layers of polyester. The 100 micron outer filter 584 (See FIG. 8A) blocks the large particulate matter extending the working life of the inner fine filter (not shown), as well as protecting the inner fine filter (not shown) from abrasion or other mechanical damage. In addition, the 100 micron outer filter 584 provides a physical separation from potentially biologically active trapped material during use and filter changes. A single filter may also be used instead of the dual filters.

The filter assembly 588 is an exterior mounted cartridge that allows removal of the inner fine filter (not shown) and the outer filter 584 without touching the active filter area. This reduces the contamination for the user. In addition the use of a filter assembly 588 allows for the insertion of fresh filters without touching the active filter area. This ensures that the filters are clean and not contaminated when put into use. Other filters known in the art or which may be developed in the future can be incorporated into the filter assembly 588 when other uses are desired.

The filter cartridge 212 can be manufactured in a variety of combinations depending on the specific material which needs to be removed. For example, a simple particle filter can be used when the concern is only dust and debris. When allergies are a concern the filter cartridge can be built with both a course particulate filter followed by a finer filter which would capture most pollens and allergens to about 5 microns. If the concern is communicable diseases such as SARS or influenza a 0.22 micron filter can be added during manufacture.

A carbon filter can also be incorporated within the filter cartridge 212 for use in an operating room. While operating rooms have excellent ventilation systems there is always some contamination by anesthetic gases. Activated carbon filters are designed to remove organic material and specific types of activated carbon filters can be designed for these anesthetic gases. This modified air filter assembly would be appropriate for anesthesiologists, nurse anesthetists, surgeons and scrub nurses.

Battery cassette 512 is provided for batteries (not shown) and contains an optional AC adaptor 514. Battery cassette 512 can include any standard batteries available in the industry. Higher capacity batteries are preferred where the present invention must have a lower weight and size, but the cost will be high. Smaller battery packs can be used to save on cost, but the running time of the invention will be reduced. Battery cassette 512 is preferably detachable by way of a snap lock mechanism (not shown) allowing for in-use exchange. Battery cassette 512 is external to the air flow area eliminating any contamination risk from dirty air and also insuring no possibility that toxic vapors from the batteries (not shown) could be introduced into the air flow. The AC adaptor 514 can also act as a charger to recharge the batteries.

In addition to placement on a belt 18, the invention has optional attachments (not shown) for use in attaching the present invention over the user's shoulder or on the user's back depending on the needs of the user.

During operation, air is drawn through filters 516 by blower 550 (See FIG. 10) and into blower housing 510. The filtered air is then carried out of the blower housing 510 into primary tube 506 and secondary tubes 508 and ultimately into face mask 502. A sensor (not shown) detects contaminant loading (i.e. a dirty filter) and signals the person 2 before air flow is significantly reduced so the filters 516 can be changed. This ensures a proper filter change cycle, minimizes the occurrence of blocked air flow, and provides the user with positive assurance the filter 516 is working properly. A low battery warning when battery cassette 512 is being used can also be indicated. The warnings can be audible, visual, vibratory or any combination.

FIG. 6 is essentially the same for the preferred embodiment as well, but the air filtering device 500 is replaced by the small scale air filtering device in the preferred embodiment illustrated in FIG. 12.

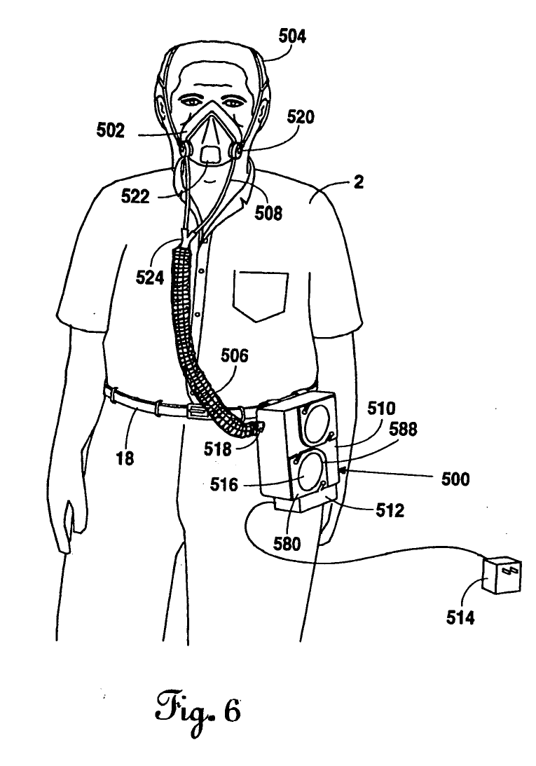

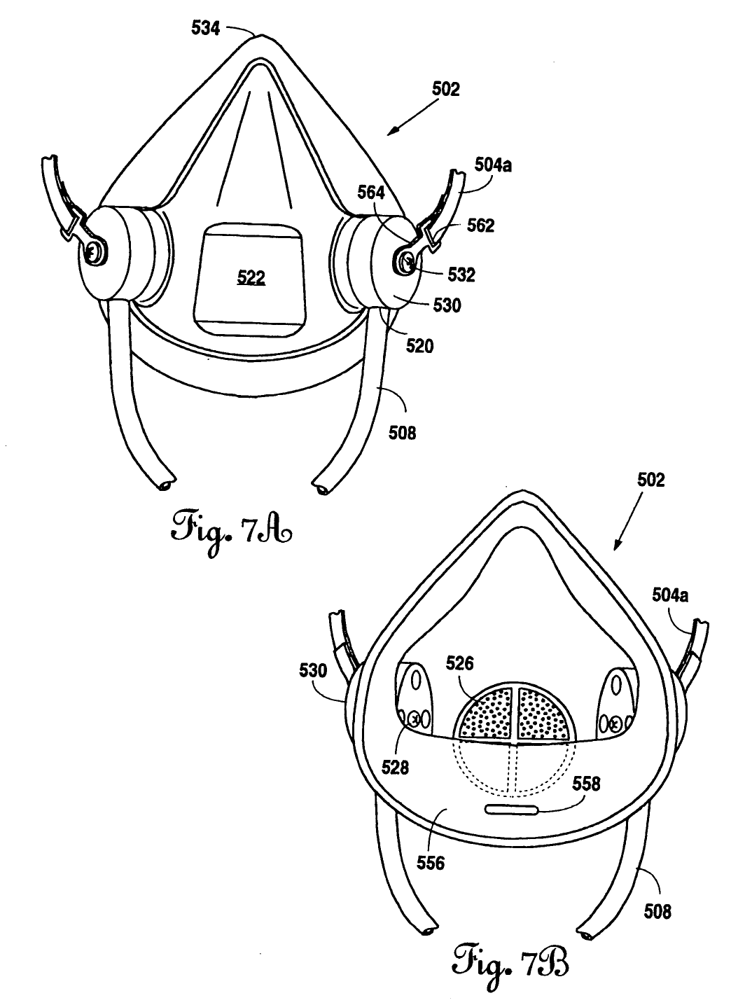

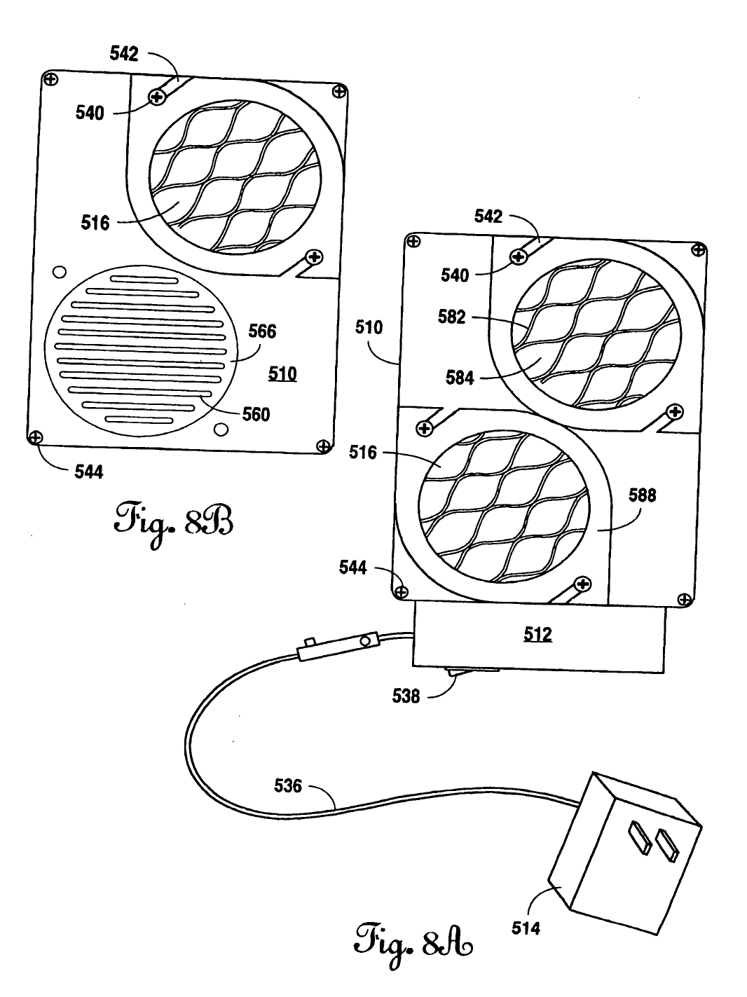

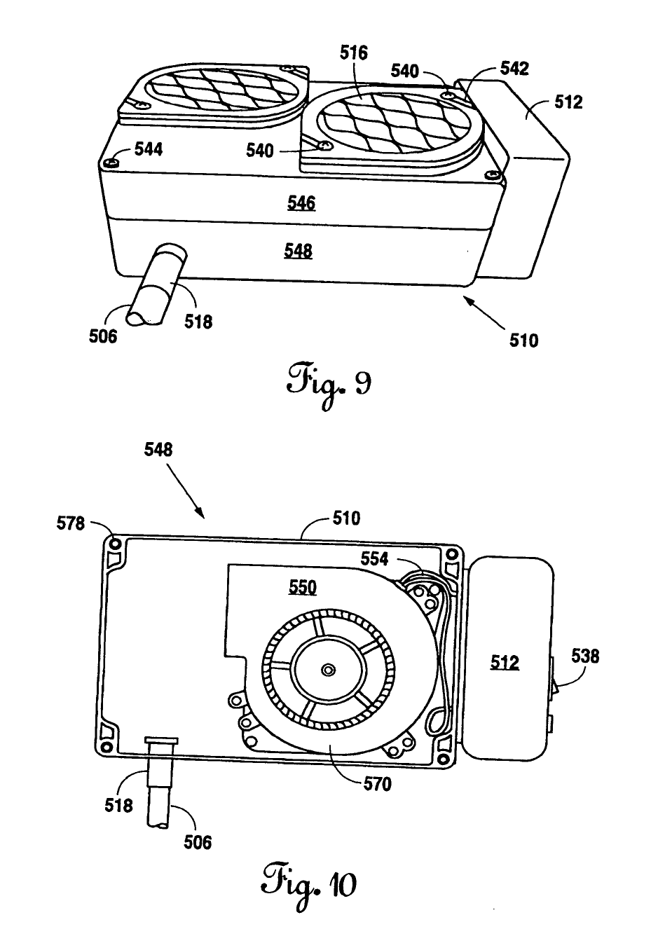

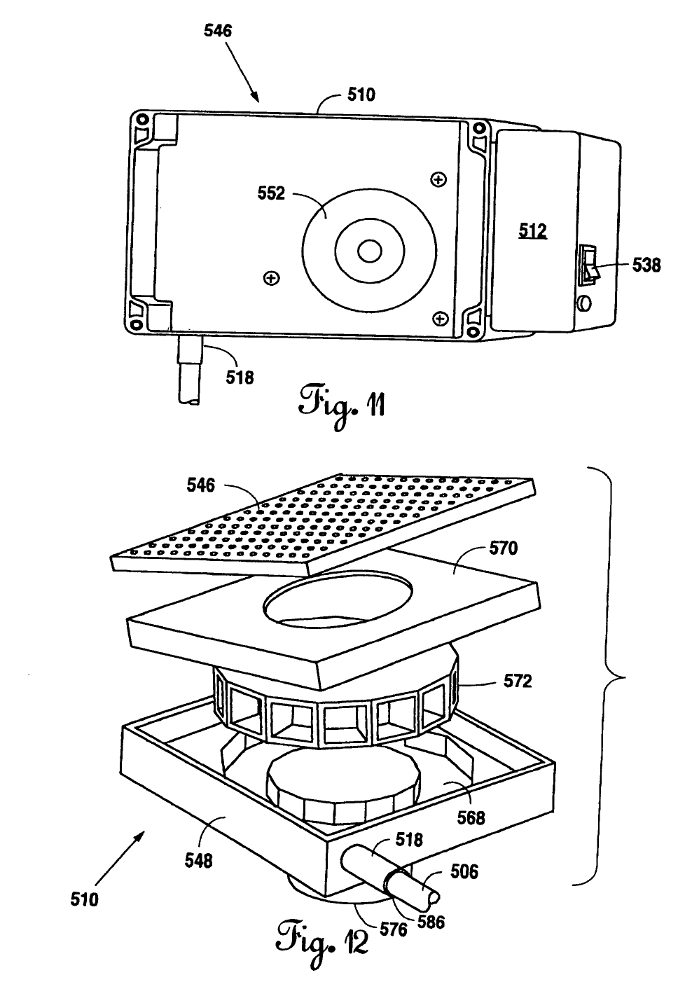

In FIG. 7A a front view of the face mask 502 of the alternative and preferred embodiments of the present invention is shown. Face mask 502 is held lightly to the mouth and nose since with positive pressure supply gaps are flushed outward reducing the potential for contamination infiltration. On each side of face mask 502 is a head band strap 504a connected through eyes 562 of members 564. Members 564 are held to face mask 502 by way of head band connectors 532. Head band connectors 532 are connected to gaskets 530 of face mask 502. Secondary tubes 508 enter gaskets 530 at inlet ports 520. Apex 534 is provided to fit over the crest of a person's nose. Exhaust filter 522 is located at the front of face mask 502. This exhaust filter 522 can be optionally snapped onto the face mask 502 to reduce the likelihood of exhaled biological contamination (bacteria or mist borne viruses). Exhaust filter 522 is useful for individuals who are infected or who do not want to risk spreading infection. An optional eye or full face shield (not shown) can be incorporated onto the face mask 502 for increased protection of the eyes.

FIG. 7B is a back view of the face mask 502 of the alternative and preferred embodiments of the present invention which shows details not only of the back of face mask 502, but also of the inside. Head band straps 504a are again provided at the sides of face mask 502 and are ultimately connected to gaskets 530. Secondary tubes 508 enter gaskets 530. Lip 556 is shown at the back incorporating a breathing hole 558 for the person 2 (See FIG. 6). Gaskets 530 continue through to the inside of face mask 502. Contained within gaskets 530 are one way inlet valves 528. The placement of these inlet valves 528 provides for optimal air flow. Inlet valves 528 can be separate components attached to face mask 502 or can be molded to face mask 502. In addition, the use of the one way inlet valves 528 allows the user to overdraw air through the filters 516 (See FIG. 6) and blower 550 (See FIG. 10) during times of increased respiration. Situated toward the front within the inside of face mask 502 is one way outlet valve 526. Outlet valve 526 can be a separate component attached to face mask 502 or can be molded to face mask 502. This outlet valve 526 is located to coincide with exhaust filter 522 (See FIG. 7A). When air is drawn in during the inhale portion of the cycle, the outlet valve 526 is sealed. When person 2 (See FIG. 6) exhales, the inlet valves 528 seal and outlet valve 526 opens.

In FIG. 8A a perspective view of the blower housing 510, battery cassette 512 and AC adaptor 514 for the alternative embodiment of the present invention is shown. Blower housing 510 is provided incorporating at least two filter assemblies 588 with filters 516 at its top. Filter assemblies 588 further include coarse outer filters 584 and metal grill work 582. Filters 516 are held in place on top of blower housing 510 by way of channels 542 allowing for rotation of filters 516 into place on connectors 540. Removable housing screws 544 are provided. Blower housing 510 is connected to a battery cassette 512. Battery cassette 512 incorporates a switch 538 for ON OFF operation. An AC adaptor 514 is provided as an optional attachment connected to battery cassette 512 by way of cord 536.

FIG. 8B is a perspective view of the housing, battery cassette and AC adaptor for the alternative embodiment of the present invention showing one of the filters 516 removed. Blower housing 510 is again provided incorporating one filter 516 at its top. Filter 516 is held in place on top of blower housing 510 by way of channels 542 allowing for rotation of filter 516 into place on connectors 540. There is provided at section 566 flow openings 560. Filters 516 are designed to be placed over these flow openings 560. Removable housing screws 544 are provided on blower housing 510.

In FIG. 9 a side perspective view of the blower housing 510 of the alternative embodiment of the present invention is shown. Blower housing 510 is provided attached to a battery cassette 512. Blower housing 510 is divided into a vacuum plenum 546 and a pressure plenum 548. Located on top of the vacuum plenum 546 are the filters 516 along with channels 542 and connectors 540. Vacuum plenum 546 is under negative pressure (vacuum) when the blower 550 (See FIG. 10) is running. This negative pressure ensures that the full surface area of the filters 516 is utilized evenly. Removable housing screws 544 hold vacuum plenum 546 to pressure plenum 548. The pressure plenum 548 is at positive pressure. This pressure plenum 548 provides for connection to the air outlet 518. Primary tube 506 connects to air outlet 518.

FIG. 10 is a top view of inside of the pressure plenum 548 of the blower housing 510 of the alternative embodiment of the present invention. Within the pressure plenum 548 of blower housing 510 is blower 550 having a blower plate 570 and connected through blower housing 510 to battery cassette 512 by electrical connections 554. The blower 550 has a fan (not shown) which can operate over a wide range of voltages, preferably in the range of about 12 VDC to 24 VDC, allowing for multiple speeds. Higher speeds or flow rates can be utilized during physical activity while lower speeds are appropriate for sedentary activity. The air flow through the blower 550 can be controlled either by a manual switch or an automatic sensing system (not shown). With the automatic system a pressure monitor (not shown) coupled to a microprocessor (not shown) can average the plenum to ambient pressure differential. If the pressure average indicates a vacuum condition (caused by the user inhaling larger volumes than being supplied), the fan speed is increased. The difference between breathing deeper and a clogged filter can be determined during the exhale portion of the cycle, i.e. as the person exhales there should be a positive pressure differential in the plenum and if the differential is small then one or both of the filters 516 are obstructed. Switch 538 is provided for ON OFF operation. Primary tube 506 is connected to blower housing 510 by way of air outlet 518.

In FIG. 11 a top view of the inside of the vacuum plenum 546 of the blower housing 510 of the alternative embodiment of the present invention is shown. Vacuum plenum 546 is attached to battery cassette 512 which has a switch 538 for ON OFF operation. Located within vacuum plenum 546 is blower seat 552 which holds blower 550 (See FIG. 10) from the pressure plenum 548 (See FIG. 10). Connected into vacuum plenum 546 is air outlet 518.

FIG. 12 is an exploded view of a small scale version of the filter device of the alternative embodiment of the present invention, being more specifically the preferred embodiment of the present invention. The small scale version anticipates the use of an integral blower housing 510 which is preferably approximately 3″×3″×1.5″ (13.5 cu. in.). It is anticipated that by using this smaller housing 510 as well as making the blower housing 510 an integral part of the assembly 500 the volume of plastic required and the resulting weight can be reduced by 75% or more from the second embodiment. The smaller housing 510 can use thinner material and still retain the structural integrity. A smaller diameter motor 576 running at a higher speed will also reduce the weight.

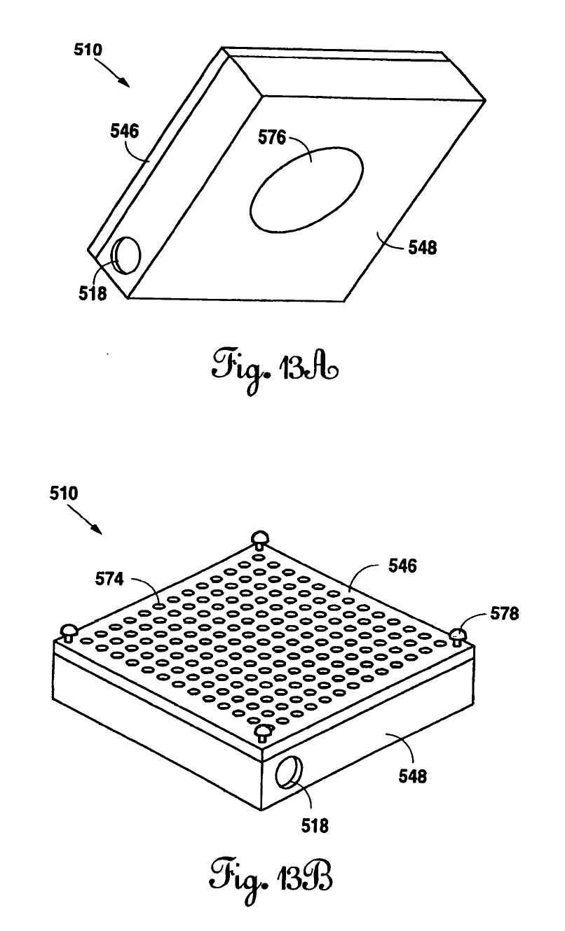

Vacuum plenum 546 is provided encasing a blower plate 570 and an impeller 572. Impeller 572 fits into pressure plenum 548 within a specially designed impeller channel 568. A motor 576 with cover plate 586 fits up into the base of pressure plenum 548. Air outlet 518 is provided which can be connected to primary tube 506. As the impeller 572 rotates, air is drawn through filters 516 (See FIG. 9) and the flow openings 574 (See FIG. 13B) or 560 (See FIG. 8B) of blower housing 510. The air then flows through a large hole in blower plate 570 and is forced out the air outlet 518 in pressure plenum 548.

In FIGS. 13A and 13B perspective views of the blower housing 510 of the preferred embodiment of the present invention are shown. Vacuum plenum 546 is provided overlapping pressure plenum 548. Motor 576 fits up into a recess within the base of pressure plenum 548. Motor 576 is sealed in place to ensure it is water and air tight. The motor shaft (not shown) extends through pressure plenum 548 so that the impeller 572 (See FIG. 12) can snap onto it. Once the impeller 572 (See FIG. 12) is in place the blower plate 570 slips over it. Blower plate 570 (See FIG. 12) nests inside pressure plenum 548 and is captured in place by vacuum plenum 546. The vacuum plenum 546 is held onto the pressure plenum 548 by latches (not shown) so that the blower housing 510 can be easily opened and closed. Air outlet 518 is provided which can be connected to primary tube 506 (See FIG. 6). Vacuum plenum 546 provides flow openings 574 upon which filters 516 rest (See FIG. 6). Pins 578 located at the corners of vacuum plenum 546 hold filters 516 (See FIG. 6). There are small slits (not shown) in each corner of filters 516 (See FIG. 6) which engage pins 578. As the filters 516 (See FIG. 6) are rotated into place, a wedging action forces the filters 516 (See FIG. 6) against vacuum plenum 546 producing a seal around the edges.

When using the present invention, the user first verifies that the air filter assembly 200 or 500 is clean and has a fresh filter 212 or 516. The user then places the blower housing 210 or 510 and batteries or battery pack 38, 40, or 512 on his or her belt 18. The air filter assembly 200 or 500 is then turned on and the face mask 7 or 502 is then placed over the user's nose and mouth. The user can now breathe normally from the supply of clean filtered air.

As the filter 212 or 516 becomes dirty, a pressure differential develops between the outside atmosphere and intake plenum (the volume between the filter and the blower intake opening). As the differential increases a sensor (not shown) triggers an alarm indicating the user should change the filter 212 or 516.

Additionally, a simple circuit (not shown) monitors the battery voltage and indicates to the user when the remaining charge has decreased to about 10% of full, thus allowing time to exit the area the user is in or to replace the batteries or battery pack 38, 40 or 512.

Once the user has finished using the air filter assembly 200 or 500 and removes and disposes of the filters 212 or 516, tubes 4 or 506 and 508, and face mask 7 or 502, the air filter assembly 200 or 500 can be easily cleaned. The face mask 7 or 502 can be detached from tubes 4 or 508 and rinsed or washed. The tubes 4 or 506 disconnect from the blower housing 210 or 510, the tubes 4 or 506 and 508 are disposed, and new tubes 4 or 506 and 508 are connected.

The user removes the dirty filter 212 or 516 and places it in a sealable plastic bag. The contaminants are primarily held in the inner layers of the filter 212 or 516 so removing the dirty filter 212 or 516 can be accomplished without risk of exposure provided basic care is taken. With the filter 212 or 516 removed, the blower housing 210 or 510 can be opened. The vacuum plenum 546 detaches from the pressure plenum 548.

Within the pressure plenum 548 is the blower plate 570 which lifts out. This plate 570 has molded into it half of the impeller shroud (not shown). The other half of the impeller shroud (not shown) is molded directly to the lower part of the pressure plenum 548. The impeller 572 lifts off the motor shaft (not shown). The motor shaft (not shown) is air and water tight, and sealed to the pressure plenum 548. The motor 576 is located in a pocket on the outside of the pressure plenum 548 and is sealed in place with a cover plate 586.

The motor 576 and battery pack 38, 40 or 512 are isolated so that once opened the unit can be washed and thoroughly cleaned. Fully opening the unit facilitates the cleaning.

The reassembly involves closing the unit, placing a fresh filter 212 or 516 on the air filter assembly 200 or 500, and reattaching fresh tubes 4 or 506 to the air outlet 518. Once reassembled the air filter assembly 200 or 500 is ready to use.

The above descriptions and illustrations show a unique portable air filtration system that can be worn by a person for extended periods of time. The entire assembly is relatively unobtrusive in appearance and can therefore be worn in public locations without embarrassment. The air filter assembly 200 or 500 is designed to be relatively inexpensive to manufacture and yet effective enough to potentially save the life of the user when exposed to harmful and potentially deadly particles floating in the ambient air.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. A portable air filtering apparatus comprising:
a face mask adapted to be held to a user's head by straps;
an exhaust filter positioned on said face mask;
at least one one-way inlet valve positioned on said face mask for optimal air flow into said face mask;
a one-way outlet valve positioned over said exhaust filter for optimal exhaust release through said exhaust filter and out of said face mask;
a blower housing adjacent said face mask defined by a pressure plenum and a vacuum plenum;
at least one tube connecting said face mask directly to said blower housing;
a power means attached outside said blower housing;
a blower positioned within said blower housing having an air flow means and driven by said power means;
flow openings through said blower housing; and
at least one filter cartridge removably attached outside said blower housing over said flow openings.

2. The portable air filtering apparatus of claim 1 wherein said at least one filter cartridge comprises two filters secured by wire mesh.

3. The portable air filtering apparatus of claim 2 further comprising a means for securing said at least one filter cartridge to said blower housing.

4. The portable air filtering apparatus of claim 3 wherein said means for securing said at least one filter cartridge to said blower housing comprises a rotation assembly having channels located on said at least one filter cartridge and a corresponding number of connectors placed on said blower housing.

5. The portable air filtering apparatus of claim 4 wherein said power means comprises a battery cassette or an AC adaptor.

6. The portable air filtering apparatus of claim 5 wherein said air flow means comprises a fan or impeller.

7. The portable air filtering apparatus of claim 6 wherein said at least one tube connects to said face mask by way of a gasket.

8. The portable air filtering apparatus of claim 7 wherein said at least one tube further comprises primary tubing connected to said blower housing and two lengths of secondary tubing connected to said face mask.

9. The portable air filtering apparatus of claim 8 wherein said primary tubing and said secondary tubing are connected by way of a Y-connector.

10. A method for use of a portable air filtering apparatus comprising the steps of:
verifying a filter cartridge located on a blower housing of said air filtering apparatus is clean, said filter cartridge being removably attached to the outside of said blower housing and covering flow openings on said blower housing;
positioning said blower housing on a user's body, said blower housing having a blower positioned therein with an air flow means and driven by a power means;
turning said air filtering apparatus to an ON position;
rotating said air flow means to begin air flow through said filter cartridge;
placing a face mask of said air filtering apparatus over said user's nose and mouth, said face mask having an exhaust filter for removal of exhaled gases, at least one one-way inlet valve positioned thereon for optimal air flow into said face mask, and a one-way outlet valve positioned over said exhaust filter for optimal removal of exhaled gases out of said face mask;
passing outside air through said filter cartridge forming filtered air;
flowing said filtered air through said flow openings into said blower housing; and
forcing said filtered air out of the blower housing into at least one tube for passage to said face mask.

11. The method for use of a portable air filtering apparatus of claim 10 further comprising the step of securing said filter cartridge to said blower housing.

12. The method for use of a portable air filtering apparatus of claim 11 wherein said securing step further comprises rotating channels on said filter cartridge onto connectors of said blower housing.

13. The method for use of a portable air filtering apparatus of claim 12 further comprising connecting at least one tube to said face mask.

14. The method for use of a portable air filtering apparatus of claim 12 further comprising connecting a primary tubing to said blower housing and two lengths of secondary tubing to said face mask.

15. The method for use of a portable air filtering apparatus of claim 13 further comprising connecting said primary tubing to said secondary tubing.

16. The method for use of a portable air filtering apparatus of claim 15 further comprising isolating said power means from said blower housing and air flow means so said blower housing and said air flow means can be easily cleaned and/or sterilized.

17. The method for use of a portable air filtering apparatus of claim 16 further comprising detaching said at least one tube and said face mask for replacement.

18. The method for use of a portable air filtering apparatus of claim 17 wherein said power means comprises a motor.

19. The method for use of a portable air filtering apparatus of claim 18 wherein said power means comprises a battery pack.
